(19) United States
(12) Patent Application Publication
(10) Pub. No.: US 2010/0082612 A1
(43) Pub. Date: Apr. 1, 2010

(54) DETERMINING RELEVANCE BETWEEN AN IMAGE AND ITS LOCATION

(75) Inventors: Manni Duan, Hefei (CN); Yongjian Wu, Beijing (CN); Yuki Arase, Osaka (JP); Xing Xie, Beijing (CN); Ruochi Zhang, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/236,512

(22) Filed: Sep. 24, 2008

(51) Int. Cl. G06F 17/30; G06K 9/46; G06K 9/66

(52) U.S. Cl. 707/724; 382/195

(57) ABSTRACT

Method for determining a relevance between an image and information pertaining to the image, including receiving information about a geographical region, displaying the image related to the geographical region, receiving an estimated location information of the image, and determining the relevance between the image and the information based on the estimated location information.

### BACKGROUND

Most image files on the web do not contain information pertaining to its locations stored therein. As a result, internet search engines rely on a web user's description of an image to conduct a search for the image. The web user's description may include text that may relate to the image or may describe the geographical location of the image. Internet search engines use this text input to search the surrounding text of a webpage, an image caption, an image file name, or information stored in the metadata of the image file. Unfortunately, these text fields may not accurately describe the actual image, and thus the results of the image search may not display the web images that the user intended for.

### SUMMARY

Described herein are implementations of various technologies for using a game to determine the relevance of an image with respect to its location. In one implementation, the game may be a web-based, multiplayer game that may be used to collect geographical data that may describe the location of an image. The game may display a portion of the image to the user and request that the user identify the geographical location that the image may relate to. Additional portions of the image may be revealed as the user continues playing the game until the user determines the location of the image. The game may then generate a score for the user. The score may be based on the distance between the user's answer and the actual location of the image, the time in which it took for the user to determine the location, the amount of the image that was displayed to the user, the difficulty level of the location or the image, if the user used a hint function, and/or combinations thereof.

The game may then evaluate the frequency that a particular image or image region was used, the scale of the image region used to identify the location of the image, and the score generated for the user after identifying the image, in order to determine the relevance between an image and its location. The relevance may be represented by a value and stored in a game log along with additional information pertaining to the image. A search engine may use the game log to rank the image search results as per its relevance to the search criteria. The image search results may comprise a list of web images that may more accurately reflect the intended web images that the user was searching.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various techniques described herein may be incorporated and practiced.

FIG. 2 illustrates a flow diagram of a method for determining the location information of an image using a game in accordance with one or more implementations of various techniques described herein.

FIG. 3 illustrates a flow diagram of a method for ranking the relevance of image search results in accordance with one or more implementations of various techniques described herein.

### DETAILED DESCRIPTION

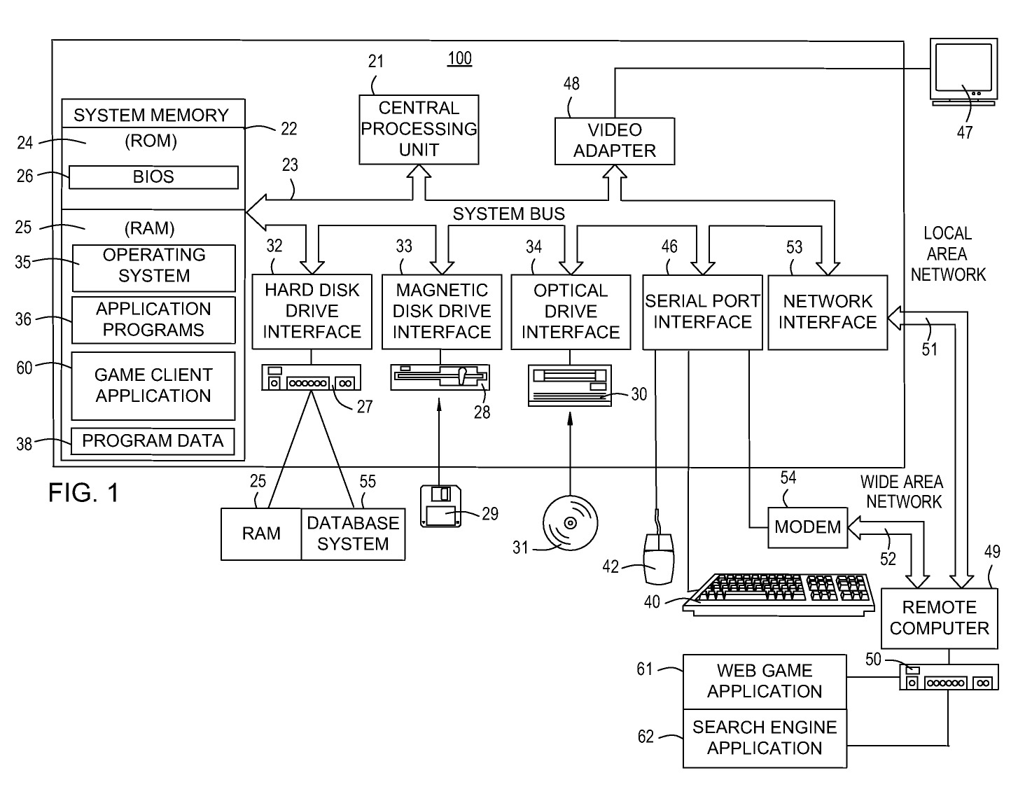

The following paragraphs provide a brief description of one or more implementations of various technologies and techniques directed at using a game to determine the relevance between an image and its location. One or more implementations of various techniques for determining the location information of an image will now be described in more detail with reference to FIGS. 1-3 in the following paragraphs.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored on the hard disk 27, magnetic disk 29, optical disk 31, ROM 24 or RAM 25, including an operating system 35, one or more application programs 36, a game client application 60, program data 38, and a database system 55. The operating system 35 may be any suitable operating system that may control the operation of a networked personal or server computer, such as Windows® XP, Mac OS® X, Unix-variants (e.g., Linux® and BSD®), and the like. The game client application 60 may be a software program that may be used to provide a user access to the web game application 61. The game client application 60 may store components related to the web game application 61 in order to support a multiplayer feature of the game.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices such as speakers and printers.

Further, the computing system 100 may operate in a networked environment using logical connections to one or more remote computers The logical connections may be any connection that is commonplace in offices, enterprise-wide computer networks, intranets, and the Internet, such as local area network (LAN) 51 and a wide area network (WAN) 52.

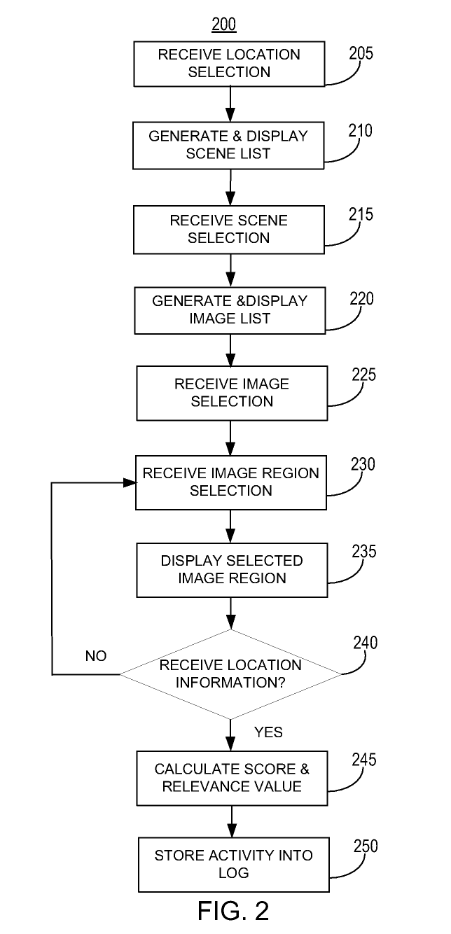

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. The remote memory storage device 50 may include the web game application 61. In one implementation, the web game application 61 may be stored on the hard disk 27, magnetic disk 29, optical disk 31, ROM 24, or RAM 25. The web game application 61 may interface with the game application 60, and it may be used to determine the location of an image. The web game application 61 will be described in more detail with reference to FIG. 2 below. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a flow diagram of a method 200 for determining the relevance between an image and its location in accordance with one or more implementations of various techniques described herein. The following description of flow diagram 200 is made with reference to computing system 100 of FIG. 1 in accordance with one or more implementations of various techniques described herein. Additionally, it should be understood that while the operational flow diagram 200 indicates a particular order of execution of the operations, in some implementations, certain portions of the operations might be executed in a different order. In one implementation, method 200 may be performed by the web game application 61.

In one implementation, the location of an image may be determined by a user via the web game application 61. The web game application 61 may be played in three different modes: cooperative, competition, or versus. The goal of each game mode is for one user to identify the location of an image. The cooperative mode may be designed to have two players assist each other in determining the location of the image, but the competition and versus modes may be designed such that one player tries to make it more difficult for the other player to determine the location of the image. Although each mode may allow the user to play the game differently, the information obtained by each game mode may be used to determine the relevance of each image with respect to its location information.

At step 205, the web game application 61 may receive a location selection from a user. The location may refer to a geographical entity such as a continent, country, state, city, or the like. In one implementation, the web game application 61 may request that the user selects a city. Typically the user may select a city that he may be familiar with in order to accurately determine the location of an image within the city's geographical limits.

At step 210, the web game application 61 may generate a list of scenes based on the input of the user at step 205. In one implementation, the web game application 61 may generate a list of scenes that may relate to different aspects of the location received at step 205. For example, if the user selected New York City at step 205, the web game application 61 may generate scenes of places located inside New York City such as Central Park, downtown, Times Square, or the like.

At step 215, the web game application 61 may randomly select or receive a scene selection from the user. In one implementation, the web game application 61 may randomly select a scene, or it may receive a scene selection from the user, depending on the mode of operation the web game application 61 may be in. In the versus mode, the web game application 61 may randomly select a scene related to the location received at step 205, but the user may select a scene in the cooperative or competition modes.

At step 220, the web game application 61 may generate a list of images that may represent the scene received at step 215. In one implementation, the web game application 61 may perform a search for images on an internet search engine using the scene received by the user as its search criteria. The web game application 61 may display the results to the user as a list of images related to the scene.

At step 225, the web game application 61 may receive an image selection from the user. In the competition and versus mode of the game, the web game application 61 may randomly select an image from the list generated at step 220, but the user may select an image in the cooperative mode. In the cooperative mode, one player may select an image that may assist another player in determining the location of the image. In one implementation, for the competition and versus modes, the web game application 61 may select and image that may have been frequently selected in the cooperation mode so that players may play with images related to the scene and so that additional information may be efficiently collected into the game logs for those images.

At step 230, the web game application 61 may then receive an image region selection from the user. The image region may include only a portion of the image. For example, an image region may consist of the bottom half of the image or a small fraction of the whole image. The amount of the image region that may be displayed may be set by the web game application 61. In one implementation, the web game application 61 may allow a user to display a region of the image that may consist of a circle that may account for a certain percentage of the image. In the cooperation mode, one player may select an image region that may indicate to another player the location of the image. In the competition and versus modes, one player may select an image region that may make it difficult to indicate to another player the location of the image. Although the various modes may have been described to require two players, it should be noted that the web game application 61 may simulate the actions of one player in the various modes of the game.

At step 235, the web game application 61 may display the selected image region. In one implementation, the selected image region may increase in size as time elapses.

At step 240, the web game application 61 may receive a location that may pertain to the image from a user. In one implementation, the user may choose to pass step 240. If the user does not input location information at step 240, the web game application 61 may return to step 230 and receive another image region selection. The web game application 61 may then repeat steps 230-240 until the user identifies the location of the image. When the user identifies the location, the web game application 61 may proceed to step 250.

At step 245, the web game application may calculate a score for the user who identified the location of the image and a relevance value for the image. In one implementation, the score that the user may receive for identifying the image may be based on the image that was used during the game and the specific region of the image that was displayed prior to the user identifying the image. The score may also be based on the distance between the user's answer and the actual location of the image, the time in which it took for the user to provide an answer, the amount of the image that was displayed to the user, the difficulty level of the location or the image, if the user used a hint function, and/or combinations thereof. Different geographical entities, different scenes, different sets of images and image regions may have different difficulty levels. The difficulty levels may be assigned based on play logs or prior knowledge.

The web game application 61 may also calculate a relevance value to denote the relevance between the image and its location. The calculation of a relevance value may account for the frequency in which an image was successfully used to describe a location, the frequency in which an image region was successfully used to describe a location, the scale of the image region that was successfully used to describe a location, the score a user obtained after successfully describing the location of an image, and/or combinations thereof. In one implementation, the web game application 61 may calculate the relevance of the image using a straightforward approach, such as a weighted sum of all the listed factors.

At step 250, the web game application 61 may store information pertaining to the user's game play activities along with other information about the game play into a game log. Other information about the game play may include a record of the image used, the image region that was displayed prior to the user identifying the location of the image, the scale of the image displayed prior to the user identifying, the score the user received for identifying the image location, the relevance value of the image, and/or combinations thereof. The game log may be stored on the hard drive 27 or on the memory storage device 50 of a server that may be accessed by an internet search engine.

Although the method 200 has been described to determine the relevance between an image and its location, it should also be noted that the method 200 may also be used to determine the relevance between an image and the content of the image. For example, the method 200 may be used to determine the relevance between an image and a celebrity in the image, a sports team in the image, an object in the image, or the like.

Although the method 200 has been described to be executed by the web game application 61, it should be understood that in some implementations the game client application 60 may be used to determine the relevance between an image and its location. Additionally, it should be understood that while the operational flow diagram 300 indicates a particular order of execution of the operations, in some implementations, certain portions of the operations might be executed in a different order. In one implementation, method 300 may be performed by the search engine application 62.

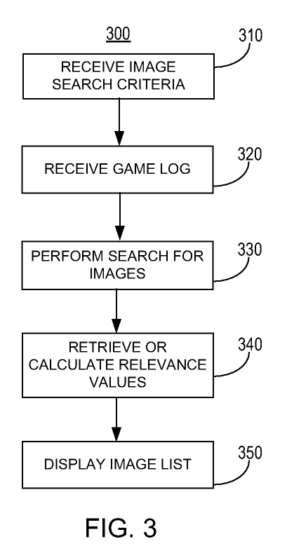

FIG. 3 illustrates a flow diagram of a method 300 that may be used to display image search results according to its relevance values in accordance with one or more implementations of various techniques described herein. The following description of flow diagram 300 is made with reference to computing system 100 of FIG. 1 in accordance with one or more implementations of various techniques described herein.

At step 310, the search engine application 62 may receive a request to search for one or more images that may be stored on a webpage. When receiving the request to search for images, the search engine application 62 may receive one or more search criteria from a user that may describe the image that the user is in searching. In one implementation, the search criteria may include information pertaining to the geographical location of the image. For example, if a user is in search of an image of the White House in Washington D.C., he may use “Washington D.C.” as the search criteria for locating an image of the White House.

At step 320, the search engine application 62 may receive a game log that may be created by the web game application 61 as described in FIG. 2. In one implementation, the game log and the search engine application 62 may be stored on the same memory storage device 50 such that the game log may be easily accessed.

At step 330, the search engine application 62 may perform a search for one or more images that may reflect the search criteria provided by the user at step 320. In one implementation, the search application 62 may use the game log in addition to its traditional methods for conducting a search for images.

At step 340, the search engine application 62 may retrieve a relevance value for each resulting image from the game log generated in FIG. 2. In one implementation, the search engine application 62 may calculate the relevance of each resulting image with respect to the search criteria. The search engine application 62 may use the information stored in the game log to determine the relevance of each image. The relevance value for each image may be determined by performing a weighted sum calculation using the information stored in the game log such as the frequency in which an image was successfully used to describe a location, the frequency in which an image region was successfully used to describe a location, the scale of the image region that was successfully used to describe a location, the score a user obtained after successfully describing the location of an image, and/or combinations thereof.

At step 350, the search engine application 62 may display a list of images that may match the search criteria provided by the user in an order of its relevance value with respect to the search criteria.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for determining a relevance between an image and information pertaining to the image, comprising:
receiving information about a geographical region;
displaying the image related to the geographical region;
receiving an estimated location information of the image; and
determining the relevance between the image and the information based on the estimated location information.

2. The method of claim 1, wherein displaying the image comprises:
displaying one or more images that relate to the geographical region to a first user;
receiving an image selection from the first user; and
displaying the image selection to a second user.

3. The method of claim 1, wherein displaying the image comprises:
selecting a random image that relates to the geographical region; and
displaying the random image.

4. The method of claim 1, wherein displaying the image comprises displaying a first portion of the image.

5. The method of claim 4, wherein displaying the image further comprises displaying a second portion of the image over time, wherein the second portion is larger than the first portion.

6. The method of claim 1, wherein determining whether the received location information substantially matches the received location comprises calculating a distance between the estimated location information and the information.

7. The method of claim 1, wherein determining the relevance between the image and the information comprises computing a weighted sum of one or more factors.

8. The method of claim 7, wherein the factors comprise:
a frequency in which the image was used to successfully determine the information of the image;
a frequency in which a portion of the image was used to successfully determine the information of the image;
a score value associated with identifying the information of the image; or
combinations thereof.

9. The method of claim 8, wherein the score value comprises:
a scale of the portion of the image used to successfully determine the information of the image;
a distance between a location associated with the estimated location information and a location associated with the information;
a time that it took to successfully determine the information of the image;
a difficulty level of the image; or
combinations thereof.

10. The method of claim 8, further comprising storing the relevance and the factors into a log.

11. A method for searching for an image, comprising:
receiving one or more search criteria pertaining to a location of an image;
searching for one or more images related to the search criteria;
obtaining a relevance rank for the one or more images from a log created by a game used to determine the relevance between the image and the location of the image; and
displaying the one or more images according to the relevance rank.

12. The method of claim 11, wherein the relevance between the image and the location is determined by:
receiving information about a geographical region;
displaying the image related to the geographical region;
receiving an estimated location information of the image; and
determining the relevance between the image and the estimated location information.

13. The method of claim 11, wherein the relevance between the image and the location is determined by computing a weighted sum of one or more factors.

14. The method of claim 13, wherein the factors comprise:
a frequency in which an image was used to successfully determine the location of the image;
a frequency in which a portion of the image was used to successfully determine the location of the image;
a score value associated with identifying the location of the image; or
combinations thereof.

15. A computer-readable medium having stored thereon computer-executable instructions which, when executed by a computer, cause the computer to:
receive information about a geographical region;
display the image related to the geographical region;
receive an estimated location information of the image;
determine the relevance between the image and the information based on the estimated location information;
store the relevance into a log;
receive one or more search criteria pertaining to a location of an image; and
display one or more images related to the search criteria using the log.

16. The computer-readable medium of claim 15, wherein the computer-executable instructions are further configured to:
search for the one or more images related to the search criteria;
obtain a relevance rank for the one or more images from the log; and
display the one or more images according to the relevance rank.

17. The computer-readable medium of claim 15, wherein the computer-executable instructions which, when executed by a computer, cause the computer to determine whether the received location information substantially matches the received location are configured to calculate a distance between the estimated location information and the information.

18. The computer-readable medium of claim 15, wherein the computer-executable instructions which, when executed by a computer, cause the computer to determine the relevance between the image and the information are configured to compute a weighted sum of one or more factors.

19. The computer-readable medium of claim 18, wherein the factors comprise:
a frequency in which the image was used to successfully determine the information of the image;
a frequency in which a portion of the image was used to successfully determine the information of the image;
a score value associated with identifying the information of the image; or
combinations thereof.

20. The computer-readable medium of claim 19, wherein the score value comprises:
a scale of the portion of the image used to successfully determine the information of the image;
a distance between a location associated with the estimated location information and a location associated with the information;
a time that it took to successfully determine the information of the image;
a difficulty level of the image; or
combinations thereof.
